(19) United States
(12) Patent Application Publication
(10) Pub. No.: US 2025/0050293 A1
(43) Pub. Date: Feb. 13, 2025

(54) CYCLONE FOR A CHEMICAL LOOPING COMBUSTION FACILITY AND METHOD PROVIDED WITH AN INLET DUCT HAVING SLOPED WALLS AND GAS INJECTION

(71) Applicants: IFP ENERGIES NOUVELLES, Rueil-Malmaison (FR); TOTALENERGIES ONETECH, COURBEVOIE (FR)

(72) Inventors: Sina TEBIANIAN, Rueil-Malmaison Cedex (FR); Thierry GAUTHIER, Rueil-Malmaison Cedex (FR); Florent GUILLOU, Rueil-Malmaison Cedex (FR)

(73) Assignees: IFP ENERGIES NOUVELLES, RUEIL-MALMAISON (FR); TOTALENERGIES ONETECH, COURBEVOIE (FR)

(21) Appl. No.: 18/720,488

(22) PCT Filed: Dec. 7, 2022
(86) PCT No.: PCT/EP2022/084843

§ 371 Date: Jun. 14, 2024

(30) Foreign Application Priority Data
Dec. 17, 2021 (FR) FR2113894

(51) Int. Cl. B01J 8/00; B04C 5/04; C10J 3/46; C10J 3/72

(52) U.S. Cl. CPC B01J 8/0055; B04C 5/04; C10J 3/463; C10J 3/725; C10J 2300/1637

(57) ABSTRACT

The present invention relates to a cyclone for gas/solid separation in a plant for chemical looping combustion of a hydrocarbon feedstock using reactors operating as circulating fluidized beds. The novel cyclone has a specific inlet pipe of which a lower wall and one of the lateral walls are inclined and which has at least one auxiliary-gas injection means at the lower wall, making it possible to reduce the deposition of solid matter at the inlet of the cyclone, to optionally carry out chemical reactions inside the cyclone, and to improve the efficiency of the cyclone.

### TECHNICAL FIELD

The present invention relates to the field of gas/solid separation, and more specifically to the field of cyclones, in the context of the chemical looping combustion of hydrocarbon feedstocks to generate energy, synthesis gas and/or hydrogen.

### PRIOR ART

In general, the present invention deals with the problem of the accumulation of solid particles in processes using the transport of particles through particle transporting lines, such as chemical looping redox processes, typically chemical looping combustion (“CLC”), using multiphase circulating beds comprising a reactive solid in contact with one or more, generally gaseous, fluid phases.

In such processes, the places where the solid accumulates in stagnation zones with a high concentration can cause numerous problems: the particles can build up, running the risk of leading to the obstruction and the partial or total blockage of the transport line; the particles can accumulate temporarily and then suddenly be made to move again in batches, which then creates fluctuations in pressure and fluctuations in the flow rate of the solid transported.

Processes taking place in multiphase circulating beds utilizing a reactive solid in contact with one or more gaseous fluid phases, such as CLC processes, conventionally use a reaction zone generally formed by a substantially vertical reactor with an ascending fluid phase, and a separation zone for separating the phases (solid/gas), which generally has a substantially vertical axis and is formed by a cyclone utilizing the centrifugal force to separate the solid particles from the gas phase. These gas/solid separators are well known to those skilled in the art.

These two vertical zones, i.e. the reactor and the cyclone, are generally connected by a transition transport zone, typically a pipe, with a length and an inclination which are conditioned by the relative locations of the reaction zone and the separation zone. Conventionally, these transition zones, in which the gas/solid mixture circulates, are substantially horizontal to preserve the tangential arrival of the stream in the cyclone. The result is therefore a change in direction, via which the deceleration of the solid encourages the particles to be deposited at the bottom of the pipe, and this can produce the phenomena described above.

One of the places where solid particles run the risk of accumulating is thus the pipe which leads to the inlet of the cyclone. The accumulation of solid particles can thus be linked to the change in direction of the gas and the deceleration of the solid during the change in direction between the reaction zone and the transition transport zone. It can also happen in the transport zone if the gas velocity in this pipe is less than the solid saltation speed. This phenomenon is described well in the literature (Gauthier et al., “Gas-solid separation in a uniflow cyclone at high solids loadings: effect of acceleration line.” Proceedings of the 3rd International Conference on Circulating Fluidized Beds, Nagoya, Japan, October 1991).

In numerous applications, the consequences of the deposition of solid particles at the bottom of the transition transport zone are fluctuations in pressure which can disrupt the operation of the process, by altering the pressure balance of the plant and giving rise to significant variations in the flow rate of the solid circulating in a loop in the plant. A drop in the separation efficiency of the cyclone can also be observed.

In applications like CLC, the solid, which can carry oxygen or ash, stagnating at high temperature can cause a buildup of particles which gradually increases as other solids particles pass. In extreme cases, this buildup can block a large portion of the inlet of the cyclone and compromise the pressure balance.

In the field of gas/solid separation in plants using circulating fluidized bed reactors, e.g. combustion chambers, gasifiers, fluid catalytic cracking reactors (“FCC”), it is known to use cyclones having an inclined inlet, notably to improve the gas/solid separation. Patent applications US2011146152 and US2008246655 thus disclose a cyclone having an inclined inlet which encourages separation between the solids particles and the gas inside the inlet pipe of the cyclone while at the same time minimizing erosion by the solids particles. The inclined inlet may comprise a lower wall inclined with respect to the horizontal, for example by an angle greater than the angle of repose of at least some of the solids particles transported. However, this type of cyclone can still exhibit the problem of accumulation of solids particles.

### Objectives and Summary of the Invention

Within this context, the present invention aims to overcome the aforementioned problems with the prior art, and thus has the overall objective of reducing the deposition of solids particles at the inlet of a cyclone of a CLC plant for combustion of a hydrocarbon feedstock, but also of optionally carrying out chemical reactions inside the cyclone, and of improving the efficiency of the cyclone.

Thus, to achieve at least one of the aforementioned objectives, among others, the present invention proposes, according to a first aspect, a cyclone for a plant for chemical looping redox of a hydrocarbon feedstock using at least one reactor operating as a circulating fluidized bed, comprising:
an inlet pipe for a gas mixture comprising solids particles coming from a reactor of the plant, this inlet pipe having at one end an inlet opening of rectangular cross section and at its other end an outlet opening of rectangular cross section,
a cylindrical-conical chamber having a cylindrical upper portion surmounting an inverted frustoconical lower portion, the cylindrical upper portion having the outlet opening of the inlet pipe;
an outlet pipe for a particle-depleted gas stream, this pipe being positioned at the top of the cylindrical upper portion;
a discharge pipe for discharging a stream of solids particles, this pipe being positioned at the bottom of the inverted frustoconical lower portion; and wherein said inlet pipe is delimited by:
   a planar upper wall in a horizontal plane (XY),
   a planar lower wall inclined by an angle α with respect to the planar upper wall 25, said angle α being defined in a vertical plane (XZ) and such that the dimension along the vertical axis (Z) of the outlet opening S of the inlet pipe is less than the dimension along the axis (Z) of the inlet opening O,
   a vertical planar outer lateral wall in the plane (XZ), this wall being tangent to the cylindrical upper portion of the cylindrical-conical chamber, and
   a vertical planar inner lateral wall inclined by an angle β with respect to the planar outer lateral wall, said angle β being defined in the horizontal plane (XY), and such that the dimension along the axis (Y) of the outlet opening S of the inlet pipe is less than the dimension along the axis (Y) of the inlet opening O, and the inlet pipe has at least one auxiliary-gas injection nozzle which is situated on the planar lower wall.

According to one or more embodiments of the invention, the cross-sectional area of the inlet opening is equal to the cross-sectional area of the outlet opening.

According to one or more embodiments of the invention, the angle α has an absolute value of between α′ and α′+45°, preferably between α′+10° and α′+20°, with α′ being the angle of repose of the particles, and the angle α preferably has an absolute value of between 15° and 60°.

According to one or more embodiments of the invention, the angle β is determined such that the cross-sectional area of the inlet opening is equal to the cross-sectional area of the outlet opening, and the angle β preferably has an absolute value of between 5° and 70°.

According to one or more embodiments of the invention, the cyclone has between 1 and 10 nozzles/m² on the planar lower wall, preferably between 2 and 5 nozzles/m² on the planar lower wall, which are distributed evenly over the surface of the planar lower wall.

According to one or more embodiments of the invention, the cross-sectional area of the outlet opening is such that the superficial velocity UgS of the gas of the gas mixture leaving said inlet pipe and entering the chamber of the cyclone is between 5 m/s and 35 m/s.

According to one or more embodiments of the invention, said at least one nozzle is configured so as to form a jet that makes an angle of between 0° and 90°, preferably between 0° and 45°, with the horizontal axis (X) in the vertical plane (XZ).

According to one or more embodiments of the invention, said at least one nozzle is configured such that the gas velocity at the outlet of said nozzle is between 5 m/s and 100 m/s, preferably between 20 m/s and 40 m/s.

According to a second aspect, the present invention proposes a chemical looping combustion plant for the combustion of a hydrocarbon feedstock using a solid-state oxygen carrier in the form of particles, comprising at least:
a reduction reactor operating as a fluidized bed to perform the combustion of said hydrocarbon feedstock in contact with said particles of the solid-state oxygen carrier;
an oxidation reactor operating as a fluidized bed to oxidize the reduced particles of the solid-state oxygen carrier coming from the reduction reactor (300) by bringing them into contact with an oxidizing gas;
means for circulating the oxygen carrier between said reduction reactor and the oxidation reactor; and
a cyclone according to the invention positioned downstream of said reduction reactor and/or downstream of said oxidation reactor so as to receive a gas mixture comprising solids particles coming from the reduction reactor or the oxidation reactor.

According to one or more embodiments of the invention, the cyclone is positioned downstream of the oxidation reactor, and said oxidation reactor comprises, in its top part, the inlet opening of the inlet pipe of said cyclone so as to send the gas mixture comprising particles of the oxygen carrier that has come from said oxidation reactor to the inlet pipe of the cyclone.

According to a third aspect, the present invention proposes a process for chemical looping combustion of a hydrocarbon feedstock using a cyclone according to the invention or a plant according to the invention, in which:
the hydrocarbon feedstock is combusted by bringing it into contact with the particles of the oxygen carrier inside a reduction reactor operating as a fluidized bed;
the particles of the oxygen carrier that have stayed in the reduction reactor are oxidized by bringing them into contact with an oxidizing gas inside an oxidation reactor operating as a fluidized bed by means of an oxidizing gas, preferably air, and then they are sent toward the reduction reactor;
a gas mixture comprising solids particles coming from the reduction reactor or the oxidation reactor is sent to the inlet pipe of the cyclone;
an auxiliary gas is injected through at least one nozzle situated on the inclined lower wall of the inlet pipe of the cyclone so as to disperse the solids particles;
gas/solid separation is performed inside said cyclone so as to form a particle-depleted gas stream extracted via the outlet pipe at the top of the cylindrical upper portion of said cyclone and so as to form a stream of solids particles discharged via the discharge pipe at the bottom of the inverted frustoconical lower portion of said cyclone.

According to one or more embodiments, the gas mixture comprising solids particles that was sent to the inlet pipe of the cyclone comes directly from the oxidation reactor, and the auxiliary gas is identical to the oxidizing gas, preferably air, of the oxidation reactor and is injected at a flow rate of between 0.1% and 30% of the flow rate of oxidizing gas utilized in the oxidation reactor.

According to one or more embodiments of the invention, the gas mixture comprising solids particles that was sent to the inlet pipe of the cyclone comes from the reduction reactor, and the auxiliary gas is dioxygen so as to also carry out a reduction of residual unburnt species present in the gas mixture, or the auxiliary gas is ammonia so as to also carry out a non-catalytic reduction of NOx present in the gas mixture.

According to one or more embodiments of the invention, the auxiliary gas is injected through said at least one nozzle at a velocity of between 5 m/s and 100 m/s, preferably between 20 m/s and 40 m/s, and forms a jet that makes an angle of between 0° and 90°, preferably between 0° and 45°, with the axis (X) in the vertical plane (XZ).

According to one or more embodiments of the invention, the superficial gas velocity of the gas mixture at the inlet of said inlet pipe is equal to the superficial gas velocity of the gas mixture at the outlet of said inlet pipe, and is between 5 m/s and 35 m/s.

Further subjects and advantages of the invention will become apparent from reading the following description of particular exemplary embodiments of the invention which are given by way of nonlimiting example, with reference to the appended figures, described below.

### LIST OF FIGURES

FIG. 1 is a schematic sectional view of a cyclone according to one embodiment of the invention and its operation.

FIG. 2 illustrates the same cyclone as that shown in FIG. 1, in a top view.

FIG. 3 is a schematic diagram of the implementation of a CLC process.

FIG. 4 illustrates an example of a cyclone according to the invention in a sectional diagram (A), in a top view (B), and in a perspective view (C).

FIG. 5 illustrates results of a simulation of the cyclone during operation shown in FIG. 4 (B) and of a conventional cyclone having an inlet in the form of a horizontal duct (A), and in particular illustrates the deposition of solids particles on the inner surface of the lower wall of the inlet of the cyclones.

FIG. 6 illustrates results of a simulation of the cyclone according to one embodiment of the invention during operation shown in FIG. 4 (B) and of a conventional cyclone having an inlet in the form of a horizontal duct (A), and in particular illustrates the amount of solids particles according to their residence time in the inlet of the cyclones.

In the figures, references that are the same denote elements that are identical or similar.

### DESCRIPTION OF THE EMBODIMENTS

The subject of the invention is to propose a cyclone for gas/solid separation in a plant for chemical looping combustion of a hydrocarbon feedstock, and more broadly in a chemical looping redox plant, using reactors operating as circulating fluidized beds.

The cyclone according to the invention has a specific inlet pipe for reducing the deposition of solids particles at the inlet of the cyclone, for optionally carrying out chemical reactions inside the cyclone, and for improving the efficiency of the cyclone, in particular the particle collection efficiency.

A chemical looping redox plant/process using at least one reactor operating as a circulating fluidized bed is understood to mean a CLC plant/process as described in more detail below, but also further chemical looping redox plants/processes such as chemical looping reforming (CLR) plants/processes or CLOU (“chemical looping oxygen uncoupling”) plants/processes.

CLC plants generally comprise two separate reactors: a reduction reactor (or combustion reactor) and an oxidation reactor (or air reactor). In the reduction reactor, the solid-state oxygen carrier is reduced by means of a fuel, or more generally a reducing gas, liquid or solid. The effluents from the reduction reactor mainly contain CO₂ and water, allowing easy capture of the CO₂. In the oxidation reactor, restoring the solid-state oxygen carrier to its oxidized state by contact with the air or any other oxidizing gas makes it possible to correspondingly generate a hot energy-carrying effluent, comprising the re-oxidized oxygen carrier, and an oxygen-poor or oxygen-depleted nitrogen stream, if air is utilized.

The present description makes reference to chemical looping redox (CLC, CLR, CLOU) plants/processes, in particular CLC plants/processes, operating as a circulating fluidized bed, which is to say under conditions in which the solid-state oxygen carrier in the form of particles is fluidized so that it can be transported and circulated in the plant.

The CLC plant and process using such a cyclone are described later on, after the following description of the cyclone.

In the present description, the expressions “active redox mass” or its abbreviated form “active mass”, “oxygen transporting material”, “solid-state oxygen carrier” or “oxygen carrier” are equivalent. The redox mass is said to be active in connection with its reactive capacities, in the sense that it is capable of acting as oxygen transporter in the CLC process by capturing and releasing oxygen.

It should be noted that, in general, the terms oxidation and reduction are used in relation to the oxidized or reduced state of the oxygen carrier, respectively. The oxidation reactor, also referred to as air reactor, is the reactor in which the oxygen carrier is oxidized, and the reduction reactor, also referred to as fuel reactor or combustion reactor, is the reactor in which the oxygen carrier is reduced. The reactors operate as fluidized beds and the oxygen carrier circulates between the oxidation reactor and the reduction reactor. The circulating fluidized bed technology is utilized to enable the continuous passage of the oxygen carrier from its oxidized state in the oxidation reactor to its reduced state in the reduction reactor.

“Cross section” is generally understood to mean a straight cross section, unless specified otherwise.

Throughout the rest of the description and in the claims, the positions (“bottom”, “top”, “above”, “below”, “horizontal”, “vertical”, “lower half”, etc.) of the various elements are defined in relation to the cyclone in an operating position.

The present description makes reference to the axis (X) which is a horizontal axis parallel to the lateral wall 27 of the inlet pipe of the cyclone. Reference is also made to the plane (XY) which is a horizontal plane, and to the plane (XZ) which is a vertical plane orthogonal to the plane (XY). These axes and planes are illustrated in the figures.

In the present description, the term “to comprise” is synonymous with (means the same thing as) “to include” and “to contain”, and is inclusive or open-ended and does not exclude other elements that are not mentioned. It should be understood that the term “to comprise” includes the exclusive and closed term “to consist”.

In addition, in the present description, the terms “essentially” or “substantially” correspond to an approximation of ±5%, preferably of ±1%. For example, an element covering substantially all of a surface corresponds to an element covering at least 95% of said surface.

Some embodiments of the cyclone, the CLC plant and the CLC process are described in detail below. Numerous specific details are presented in order to provide a deeper understanding of the invention. However, it will be apparent to those skilled in the art that the cyclone, the CLC plant and the CLC process can be utilized without all of these specific details. In other cases, well-known characteristics have not been described in detail in order to avoid unnecessarily complicating the description.

In the present description, the expression “between . . . and . . . ” means that the limiting values of the interval are included in the described range of values, unless specified otherwise.

### The Cyclone

In order to reduce the deposition of solids particles at the inlet of a cyclone, a novel cyclone for gas/solid separation that is suitable for CLC plants and processes is proposed. This type of cyclone has good separation efficiency, and can advantageously make it possible to carry out chemical reactions inside the cyclone.

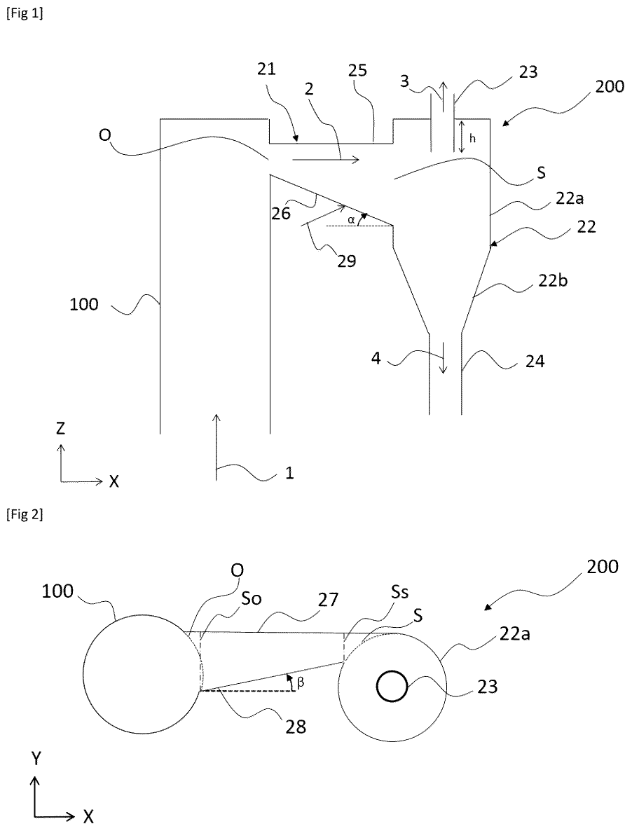

FIGS. 1 and 2 schematically and nonlimitingly illustrate one embodiment of the cyclone according to the invention.

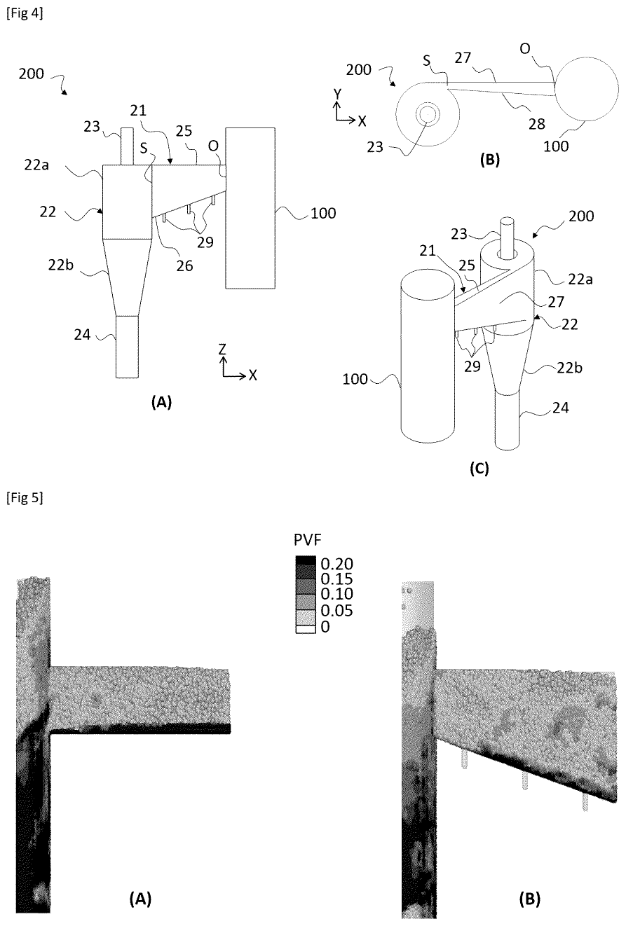

FIG. 4 also illustrates an example of a cyclone according to the embodiment illustrated in FIGS. 1 and 2, serving to illustrate certain performance aspects of the cyclone according to the invention, as will be described in more detail in the “Example” section.

In these figures, references that are the same denote elements that are identical or similar.

With reference to these figures, the cyclone according to the invention comprises:
an inlet pipe 21 for a gas mixture 2 comprising solids particles coming from a reactor 100 of a CLC plant, said inlet pipe 21 having at one end an inlet opening O of rectangular cross section So and at its other end an outlet opening S of rectangular cross section Ss,
a cylindrical-conical chamber 22 having a cylindrical upper portion 22a surmounting an inverted frustoconical lower portion 22b (in other words the narrowest portion of the cone frustum is in the lower part), the cylindrical upper portion 22a having the outlet opening S of the inlet pipe;
an outlet pipe 23 for a particle-depleted gas stream 3, this pipe being positioned at the top of the cylindrical upper portion; and
a discharge pipe 24 for discharging a stream of solids particles 4, this pipe being positioned at the bottom of the inverted frustoconical lower portion 22b.

In the cyclone according to the invention, the inlet pipe 21 is delimited by:
a planar upper wall 25 in a horizontal plane (XY),
a planar lower wall 26 inclined by an angle α with respect to the planar upper wall 25, said angle α being defined in a vertical plane (XZ) and such that the dimension along the vertical axis (Z) of the outlet opening S of the inlet pipe is less than the dimension along the axis (Z) of the inlet opening O (in other words, in the operating position, the highest point of the planar lower wall 26 is next to the inlet opening O of the inlet pipe and the lowest point of the planar lower wall 26 is next to the outlet opening S of the inlet pipe),
a vertical planar outer lateral wall 27 in the plane (XZ), this wall being tangent to the cylindrical upper portion of the cylindrical-conical chamber 22, and
a vertical planar inner lateral wall 28 inclined by an angle β with respect to the planar outer lateral wall 27, said angle β being defined in the horizontal plane (XY), and such that the dimension along the axis (Y) of the outlet opening S of the inlet pipe is less than the dimension along the axis (Y) of the inlet opening O.

According to the invention, the inlet pipe 21 has at least one auxiliary-gas injection nozzle 29 which is situated on the planar lower wall.

The cyclone according to the invention is of the tangential-inlet reverse-flow cyclone type. In this type of cyclone, the gas mixture containing solids particles enters the cyclone at the top and is subjected to a centrifugal movement as a result of being admitted tangentially. The particles are propelled towards the wall of the cyclone by the centrifugal force and then drop down along the wall under the effect of gravity. At the bottom of the cyclone, in the inverted frustoconical section, the gas stream, rid of the particles that are discharged at the bottom of the frustoconical section, reverses direction to form an internal vortex which leaves the cyclone via an axial duct at the top of the cyclone. In the cyclone according to the invention, the outlet pipe 23 is preferably situated along the axis of the chamber of the cyclone, and may have an inner cylindrical part over a height h, generally referred to as the “vortex finder” as is conventional in a reverse-flow cyclone.

The gas mixture 2 comprising solids particles typically comes from a reactor 100 of a CLC plant comprising an ascending multiphase gas/solid stream 1. This ascending stream changes direction once it has entered the inlet pipe 21 through the inlet opening O, and is designated as the gas mixture 2 comprising solids particles that enters the inlet pipe in the present description.

The specific inlet of the cyclone according to the invention, characterized by its particular geometry and the one or more auxiliary-gas injection nozzles 29, makes it possible to limit the deposition of solids particles in the inlet pipe of the cyclone. This is because the downward inclination of the lower wall 26 of the inlet pipe 21 (angle α) promotes the flow and re-acceleration of the solids particles toward the outlet opening S of the inlet pipe 21, in the direction toward the chamber of the cyclone, and the one or more injection nozzles 29 make it possible to inject an auxiliary gas so as to disperse the solids particles. In particular, the injected auxiliary gas makes it possible to reorientate the solids particles that fall onto the lower wall 26 toward the main gas stream in the inlet pipe 21, and destroy any buildup of particles there might be.

The specific inlet of the cyclone according to the invention, in particular the presence of at least one auxiliary-gas injection nozzle 29, can also make it possible to carry out chemical reactions inside the cyclone. For example, it is possible, if required, to complete any ongoing reactions with the solids particles, typically the solid-state oxygen carrier, or to carry out chemical reactions not involving the solid-state oxygen carrier inside the cyclone. As a result, when the cyclone is placed at the outlet of an air reactor of a CLC plant, it is possible according to the invention to inject an oxidizing gas, for example the same oxidizing gas as that utilized in the air reactor to re-oxidize the particles of the oxygen carrier, e.g. air, or another oxidizing gas, in order to complete the oxidation of the particles of the oxygen carrier. These possible chemical reactions permitted by the injection of auxiliary gas are described in detail below in relation to the description of the CLC plant and process according to the invention.

The specific inlet of the cyclone according to the invention, characterized by its particular geometry and the one or more auxiliary-gas injection nozzles 29, also makes it possible to provide a cyclone which has good separation efficiency. For the one part, the deposition of solids particles in the inlet pipe 21 is reduced, by virtue of the injection of auxiliary gas through the one of more injection nozzles 29 and the specific geometry of the inlet pipe 21, notably the inclined lower wall 26, thereby making it possible to not obstruct the inlet of the cyclone and to not disrupt the operation of the cyclone, it then being possible for the gas/solid separation to be done correctly. Correspondingly, the dispersal of the solids particles in the main gas stream allows them to be carried into the chamber 22 of the cyclone, thereby enabling better gas/solid separation than is achieved if these same particles are allowed to stagnate and build up on the lower wall 26 of the pipe. Furthermore, the inclination of the lateral wall 28 of the inlet pipe 21 by an angle β makes it possible to preferentially direct the particles toward the wall at the inlet of the chamber of the cyclone, thereby making it possible to improve the collection efficiency of the cyclone, by on the one hand minimizing the distance the particles need to travel to get to the wall of the chamber of the cyclone, but also by encouraging the winding of the gas in the cyclone, limiting the particles being carried back toward the outlet 23 in the inlet zone of the cyclone.

The gas velocity UgO at the inlet opening O of the inlet pipe 21 depends on the physical properties of the solids particles that circulate and on the design of the cyclone.

As a preference, the cross-sectional area Ss of the outlet opening S is such that the superficial gas velocity UgS of the gas mixture leaving said inlet pipe 21 and entering the chamber of the cyclone is between 5 m/s and 35 m/s, and more preferentially between 15 m/s and 25 m/s, in order to achieve good separation performance.

In the present description, the cross section of the inlet pipe 21, in particular the cross section So of the inlet opening O and that Ss of the outlet opening S of the inlet pipe, is understood to mean a straight cross section. This is clearly shown in FIG. 2. It is in particular orthogonal to the planar outer surface 27 of the inlet pipe 21.

Advantageously, the cross-sectional area So of the inlet opening O of the inlet pipe 21 is equal to the cross-sectional area Ss of the outlet opening S of said inlet pipe 21. Thus, the superficial gas velocity UgO of the gas mixture 2 entering said inlet pipe is equal to the superficial velocity UgS of the gas leaving said pipe. This notably makes it possible to limit any erosion of the cyclone and attrition of the particles that is associated with heavy impact against the walls of the cyclone, which is something that could occur if the gas velocity were to increase.

With preference, the cross-sectional area of the inlet pipe is constant from the inlet opening O to the outlet opening S of the inlet pipe 21, ensuring a constant superficial gas velocity along the inlet pipe.

Although, according to the invention, the superficial gas velocity UgO at the inlet opening of the inlet pipe is preferably equal to the superficial gas velocity UgS at the outlet opening of the inlet pipe, it would not constitute a departure from the scope of the invention if UgO were less than UgS, in particular if UgO were between 0.5 times and 1 time UgS, or even were between 0.75 times and 1 time UgS.

The planar lower wall 26 is inclined by an angle α, defined in a vertical plane (XZ), with respect to the horizontal planar upper wall 25, and such that the dimension along the vertical axis (Z) of the outlet opening S of the inlet pipe is less than the dimension along the axis (Z) of the inlet opening O, as clearly shown in FIG. 1. Owing to this angle α, the planar lower wall 26 is inclined downward in relation to the horizontal axis (X), from the inlet opening O toward the outlet opening S situated in the portion of the inlet pipe 21.

The angle α preferably has an absolute value of between α′ and α′+45°, preferably of between α′+10° and α′+20°, with α′ being the angle of repose of the particles.

The angle of repose or natural slope angle of the particles is traditionally defined as being the angle between the gradient of the heap of uncompacted powder and the horizontal direction and may be determined in various ways. For example, this angle may be measured by pouring powder through a funnel so as to form a small heap of product characterized by a gradient with respect to the horizontal surface. The angle of repose may also be measured by making a solid slide along a tilting plate, the angle of repose then being measured as being the angle at which the solid material begins to slide, or by using a rotary cylinder to determine the angle that allows the solid to flow. These last two methods are preferably used to determine the angle of repose because they involve movement of the solid.

The angle α may have an absolute value of between 5° and 80°, preferably between 15° and 60°, more preferably between 15°, and 45°, and more preferably still between 20° and 45°.

The inclination of the lower wall of the inlet pipe makes it possible to reduce the saltation speed of the particles, and consequently the accumulation of the particles.

The planar inner lateral wall 28 is inclined by an angle β, defined in the horizontal plane (XY), with respect to the planar outer lateral wall 27, and such that the dimension along the axis (Y) (i.e. the width) of the outlet opening S of the inlet pipe is less than the dimension along the axis (Y) (i.e. the width) of the inlet opening O, as clearly shown in FIG. 2.

With preference, the angle β is determined such that the cross-sectional area So of the inlet opening O is equal to the cross-sectional area Ss of the outlet opening S. In this way, it is possible, by way of a given inclination of the inner lateral wall, to keep the inlet and outlet cross-sectional areas of the inlet opening 21, and consequently the superficial gas velocities associated therewith, the same. As a result, erosion of the cyclone and attrition of the particles are reduced, as already mentioned above, and at the same time the deposition of solids particles in the inlet pipe of the cyclone and the associated problems are limited.

The angle β may have an absolute value of between 5° and 70°, preferably between 10° and 50°.

In the inlet pipe 21, the one or more injection nozzles make it possible to inject the auxiliary gas so as to disperse the solids particles and further limit the deposition of solids particles in the inlet pipe. The presence of such a gas, depending on its nature and the temperature and pressure conditions prevailing in the cyclone, can also make it possible to carry out chemical reactions in the cyclone. These reactions are described in detail later on in relation to the description of the CLC plant and process.

The number of nozzles for injecting the auxiliary injection gas depends on the total flow rate of the auxiliary gas injected.

Advantageously, the cyclone has a nozzle density of between 1 and 10 nozzles per square meter, and preferably between 2 and 5 nozzles per square meter. The reference surface for the density of the nozzles is that of the planar lower wall 26 of the inlet pipe 21. The nozzles can, for example, be evenly distributed along a longitudinal central axis of the lower wall of the inlet pipe 21, from the inlet opening O to the outlet opening S. They are preferably evenly distributed over the lower planar surface, for example along an axis or multiple secant axes, for example at the intersections of secant axes in a square, rectangular, triangular etc. pattern. For example, the cyclone according to the invention has an inlet pipe having three equidistant injection nozzles distributed over the lower wall of the inlet pipe 21, along the longitudinal central axis of said lower wall, as shown in FIG. 4.

The one or more nozzles are preferably configured to form a jet that makes an angle of between 0° and 90°, preferably greater than 0° and less than 90°, and more preferentially between 0° (and preferably greater than) 0° and 45°, with the horizontal axis (X) in the vertical plane (XZ). The jet formed is thus preferably directed along the axis of flow of the gas mixture in the pipe, so as not to excessively disrupt the stream heading toward the body of the cyclone. Advantageously, the one or more nozzles are configured in such a way that the gas velocity at the outlet of said nozzle is between 5 m/s and 100 m/s, preferably between 20 m/s and 40 m/s, so as to prevent solid particles from getting back into the nozzle, in order to obtain good dispersal of the solids particles and break down any buildups.

According to the invention, the cyclone is advantageously used in a CLC plant, and typically operated under the pressure and temperature conditions of a CLC process as described in detail below. It is thus preferably made from materials suited to the high temperatures encountered in CLC, typically of between 800° C. and 1000° C., or even between 600° C. and 1400° C., for example, and, nonlimitingly, high-temperature steels such as those of the Hastelloy®, Incoloy®, Inconel® or Manaurite® type, or conventional steels, for example of the stainless steel or carbon steel type combined with refractory materials or combined with cooling means such as tubes in which a heat-transfer fluid flows.

The cyclone is well suited to the gas/solid separation of gas mixtures comprising solids particles with a mean particle diameter of between 20 μm and 1000 μm.

The cyclone is well suited to the gas/solid separation of gas mixtures comprising a content of solids particles of preferably between 0.1 and 50 wt/wt (weight of the solids particles with respect to the weight of the gas).

To give dimensional orders of magnitude, nonlimitingly, the cyclone according to the invention may have a total height of several meters (height of the cylindrical-conical chamber), for example 5 meters, a diameter of the cylindrical upper part (“barrel”) of the cylindrical-conical chamber of around one meter, for example 1 meter, and comprise an inlet pipe of rectangular cross section on the scale of below one meter or one meter, for example 0.6 meters×0.2 meters, and with a length of several meters, for example 2.5 meters. A cyclone exhibiting the given exemplary values mentioned enables, for example, processing of 0.9 kg/s of gas and a flow rate of solid matter of 30 kg/s.

### CLC Plant and Process

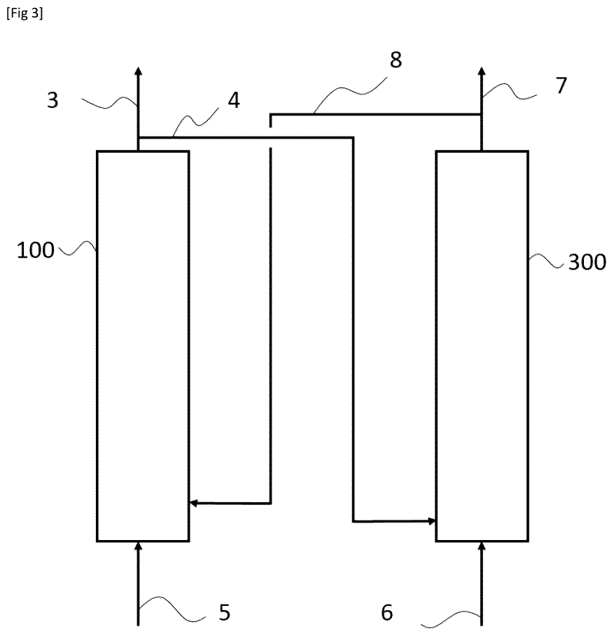

FIG. 3 is a diagram showing the general operating principle of chemical looping combustion. It in no way limits the cyclone according to the invention, which may be used in the CLC plant and process of the invention.

A reduced oxygen carrier 8 is brought into contact with an oxidizing-gas stream 5, typically air, in a reaction zone 100 defined above as the oxidation reactor (or air reactor). This results in a depleted air stream 3 and a stream of re-oxidized particles 4. The stream of particles of oxidized oxygen carrier 4 is transferred to the reduction zone 300 defined above as the combustion reactor (or reduction reactor). The stream of particles 4 is brought into contact with a fuel 6, which is a hydrocarbon feedstock. This results in a combustion effluent 7 and a stream of particles of reduced oxygen carrier 8. For the sake of simplicity, the illustration in FIG. 3 does not comprise the various items of equipment which can form part of the CLC unit, for solid/gas separation, solid/solid separation, heat exchange, pressurization, gastightness between the reactors (e.g. siphons), storage of the solid matter, control of the streams of solid matter (e.g. mechanical or pneumatic valves) or any recirculations of material around the oxidation and combustion reactors. In particular, FIG. 3 does not include the cyclone to which the invention relates and which is illustrated in FIGS. 1, 2 and 4.

In the combustion zone 300, the hydrocarbon feedstock 6 is brought into contact, co-currentwise, with the oxygen carrier in the form of particles so as to perform the combustion of said feedstock by reduction of the oxygen carrier.

The oxygen carrier MₓO_{y}, with M representing a metal, is reduced to the MₓO_{y-2n-m/2} state by means of the CₙHₘ hydrocarbon feedstock, which is correspondingly oxidized to give CO₂ and H₂O, according to the reaction (1) below, or optionally to give a CO+H₂ mixture, according to the proportions used.

$$[ Math 1 ]$$

$${C}_{n} {H}_{m} + {M}_{x} {O}_{y} \to n {CO}_{2} + m / 2 {H}_{2} O + {M}_{x} {O}_{y - 2 n - m / 2} \qquad ( 1 )$$

The complete combustion of the hydrocarbon feedstock is generally targeted.

The combustion of the feedstock in contact with the oxygen carrier is carried out at a temperature generally of between 600° C. and 1400° C., preferentially between 800° C. and 1000° C. The contact time varies depending on the type of combustible feedstock used. It typically varies between 1 second and 20 minutes, for example preferably between 1 minute and 10 minutes, and more preferentially between 1 minute and 8 minutes for a solid or liquid feedstock, and for example preferably from 1 to 20 seconds for a gaseous feedstock.

A mixture comprising the gases resulting from the combustion and the particles of the oxygen carrier is discharged at the top of the reduction zone 300. Gas/solid separation means (not shown), such as a cyclone, make it possible to separate the combustion gases 7 from the solids particles of the oxygen carrier in their most reduced state 8. If particles of unburnt residues are present, which may occur if the hydrocarbon feedstock is solid, a solid/solid separation device for separating the particles of unburnt residues from the particles of the oxygen carrier can be used at the outlet of the combustion reactor. This type of separator can be combined with one or more gas/solid separators situated downstream of the solid/solid separator, for example with a cyclone according to the invention. The particles of the oxygen carrier which have stayed in the combustion reactor, and separated from the combustion gases, are sent to the oxidation zone 100 to be re-oxidized. The particles of unburnt residues can be recycled to the reduction reactor 300.

In the oxidation reactor 100, the oxygen carrier is restored to its MₓO_{y} oxidized state on contact with an oxidizing gas 5, typically air or water vapor, and preferably air, according to the reaction (2) below, before returning to the reduction reactor 300, and after having been separated from the oxygen-depleted gas 3, typically “depleted” air, are discharged at the top of the oxidation reactor 100.

$$[ Math 2 ]$$

$${M}_{x} {O}_{y - 2 n - m / 2} + ( n + m / 4 ) {O}_{2} \to {M}_{x} {O}_{y} \qquad ( 2 )$$

In reaction (2), n and m represent the number of carbon and hydrogen atoms, respectively, which have reacted with the oxygen carrier in the combustion reactor.

The temperature in the oxidation reactor is generally between 600° C. and 1400° C., preferentially between 800° C. and 1000° C.

The oxygen carrier, changing alternately from its oxidized form to its reduced form and vice versa, describes a redox cycle.

The hydrocarbon feedstocks (or fuels) processed can be solid, gaseous or liquid hydrocarbon feedstocks, and are preferably solid or gaseous feedstocks. The solid feedstocks can be chosen from coal, coke, pet-coke, biomass, tar sands and household waste. The gaseous feedstocks are preferably essentially made up of methane, for example natural gas or a biogas. The liquid feedstocks can be chosen from petroleum, bitumen, diesel or gasoline. Preferably, the hydrocarbon feedstock processed is a solid or gaseous feedstock, as stated above.

The oxygen carrier can be composed of metal oxides, such as oxides of Fe, Ti, Ni, Cu, Mn, Co or V, alone or as a mixture, which can originate from ores (for example ilmenite or pyrolusite) or be synthetic (for example copper oxide particles supported on alumina, CuO/Al₂O₃, or nickel oxide particles supported on alumina, NiO/Al₂O₄), with or without a binder, and exhibits the required redox properties and the characteristics necessary for carrying out the fluidization. The oxygen storage capacity of the oxygen carrier is advantageously, depending on the type of material, between 0.5% and 15% by weight. Advantageously, the amount of oxygen effectively transferred by the metal oxide is between 0.5% and 3% by weight, which makes it possible to use only a fraction of the total oxygen transfer capacity, ideally less than 30% of the latter, in order to limit the risks of mechanical aging or buildup of the particles. The use of only a fraction of the oxygen transportation capacity also has the advantage that the fluidized bed acts as a thermal ballast and thus smooths the variations in temperature on the route of the oxygen carrier.

The oxygen carrier is in the form of fluidizable particles, belonging to groups A, B, C or D of the Geldart classification, preferably to groups A, B, or D, alone or in combination. The particles of the oxygen carrier preferably belong to group B of the Geldart classification. By way of example, and nonlimitingly, the particles of group B that are used exhibit a particle size such that more than 90% of the particles have a size of between 100 μm and 500 μm, preferably of between 150 μm and 300 μm.

Preferably, the particles of the oxygen carrier, which can be metal oxides, which are synthetic or natural ores, supported or not, have a density of between 1000 kg/m³ and 5000 kg/m³ and preferentially between 1200 kg/m³ and 4000 kg/m³.

For example, the nickel oxide particles supported on alumina (NiO/NiAl₂O₄) generally exhibit a grain density of between 2500 kg/m³ and 3500 kg/m³, typically of approximately 3200 kg/m³, depending on the porosity of the support and on the nickel oxide content.

Ilmenite, an ore combining titanium and iron (titanium iron oxide), exhibits a density of 4700 kg/m³.

The oxygen carrier can undergo a phase of activation so as to increase its reactive capacities, which may consist of a phase of rise in temperature, preferably a gradual one, preferably under an oxidizing atmosphere (for example under air).

The oxidation and combustion reactors operate as fluidized beds. They each comprise at least one fluidization-gas injection system. In the combustion reactor, the fluidization gas can be CO₂, which may be CO₂ that was generated during the combustion and recycled, or water vapor. In the oxidation reactor, the fluidization gas is an oxidizing gas, preferably air.

The oxidation reactor 100 preferably comprises a transport fluidized bed. Advantageously, the velocity of the gas (gas phase of the bed) is between 2 m/s and 15 m/s, and preferentially between 3 m/s and 10 m/s. By way of example, such an oxidation reactor may have a diameter of between 1 m and 6 m for a height of between 10 m and 30 m.

The oxidation reactor is thus configured to receive the particles of the oxygen carrier that have stayed in the combustion reactor, so as to oxidize said particles inside the transport bed, and to send them to said combustion reactor.

The combustion reactor 300 may be configured to comprise a dense fluidized bed. As a preference, the superficial gas velocity in the dense fluidized bed of the reactor, which is also referred to here as operational superficial gas velocity Ug, is between 0.1 m/s and 3 m/s, preferably between 0.3 m/s and 2 m/s.

By way of example, the combustion reactor 300 may have a diameter D_{R} of between 1 m and m. According to the invention, the combustion reactor preferably has a height HR to diameter D_{R} ratio of between 0.5 and 8, preferably of between 1 and 5, and more preferentially still of between 2 and 4. The same can be said of the ratio of the height of the dense fluidized bed in the reactor to the diameter of the reactor.

Dense fluidized bed is understood to mean a bubbling bed (bubbling regime, also referred to as bubble regime) or a turbulent bed (turbulent regime). The fraction by volume of solid matter in such a dense fluidized bed is generally between 0.20 and 0.50.

In instances where it is solid hydrocarbon feedstocks that are combusted, a sufficiently long contact time for the contact of the feedstock with the particles of the oxygen carrier is generally needed in order to tend towards complete combustion, and entails a first phase of gasifying the solid feedstock, followed by combustion of the gasified feedstock. The two phases may be carried out in the dense fluidized bed of the combustion reactor. In another configuration, the first phase may be carried out in the dense fluidized bed of the combustion reactor, and the second phase may be carried out in another combustion zone, for example within the same reactor in a zone surmounting the dense bed and operating as a dilute fluidized bed or in a separate reactor that receives the gasified feedstock and brings it into contact with the oxygen carrier within a dense or dilute fluidized bed.

Dilute fluidized bed is understood to mean a transport bed. The fraction by volume of solid matter is generally less than 0.20.

The combustion reactor 300 may thus be configured to comprise a dilute fluidized bed.

In the case of the chemical looping combustion of gaseous feedstocks, for example, as the contact time required for contact between the particles of the oxygen carrier and the feedstock is less than in the case of solid or liquid feedstocks, a riser-type reactor or reactor part, forming a substantially elongate and vertical duct and operating as a dilute fluidized bed may be sufficient to carry out the combustion of the feedstock and convey the particles.

In the combustion reactor or reactor part that is operating as a dilute fluidized bed, the velocity is preferably greater than 3 m/s and less than 30 m/s, more preferentially between 5 and 15 m/s, so as to facilitate the conveying of all of the particles while at the same time minimizing pressure drops so as to optimize the energy efficiency of the process.

The geometry of the reactors may be parallelepipedal, typically a rectangular parallelepiped, cylindrical or any other three-dimensional geometry preferably exhibiting a symmetry of revolution. The term “cylindrical” refers to a cylinder of revolution. For example, the combustion reactor is cylindrical or has a rectangular parallelepipedal shape. In this latter instance, the diameter D_{R} of the reactor must be understood as an equivalent diameter, defined as the diameter of the circle inscribed in the cross section of the reactor.

The materials used to construct the reactors and their constituent elements (inlet(s), discharge point(s), outlet(s), etc.) can be selected from refractory materials, for example of the refractory concrete, refractory brick or ceramic type, high temperature steels, for example of Hastelloy®, Incoloy®, Inconel® or Manaurite® type, or conventional steels, for example of stainless steel or carbon steel type, combined with refractory materials or combined with cooling means, such as tubes in which a heat-transfer fluid circulates.

The present invention also relates to a CLC plant which comprises at least:
a reduction reactor 300 operating as a fluidized bed to perform the combustion of the hydrocarbon feedstock in contact with the particles of the solid-state oxygen carrier;
an oxidation reactor 100 operating as a fluidized bed to oxidize the reduced particles of the solid-state oxygen carrier coming from the reduction reactor 300 by bringing them into contact with an oxidizing gas;
means for circulating the oxygen carrier between the reduction reactor 300 and the oxidation reactor 100; and
a cyclone according to the invention, as described above, positioned downstream of the reduction reactor 300 and/or downstream of the oxidation reactor 100 so as to receive a gas mixture comprising solids particles coming from the reduction reactor 300 or the oxidation reactor 100.

According to one or more preferred embodiments, the cyclone is positioned downstream of the oxidation reactor 100, and is connected directly, i.e. without any other intermediate chamber or device, to said oxidation reactor 100 so as to receive, via the inlet pipe 21, a gas mixture comprising particles of the oxygen carrier that has come from said oxidation reactor 100. Advantageously, the oxidation reactor 100 comprises, in its top part, the inlet opening of the inlet pipe of said cyclone, so as to send a gas mixture comprising particles of the oxygen carrier that has come from the oxidation reactor 100 directly to the inlet pipe of said cyclone. Such a configuration notably has the advantage that the auxiliary gas injected into the inlet pipe of the cyclone, if it is of the same nature as the same oxidizing gas as that utilized in the oxidation reactor, e.g. air, makes it possible to continue the oxidation reaction for oxidizing the oxygen carrier, this reaction notably being facilitated because of the higher concentration of the oxygen carrier in the inlet pipe of the cyclone than in the oxidation reactor 100. This has the effect of improving the degree of progress made in the reactions (of the oxygen carrier), and has substantially the same effect as adding this gas stream to the oxidation reactor upstream, without needing to substantially increase its size to meet the same fluidization conditions. Furthermore, this injection of auxiliary gas into the inlet pipe of the cyclone is done in fact at a lower pressure than the upstream injection of oxidizing gas into the oxidation reactor, and accordingly makes it possible to save on energy in comparison with a configuration in which the auxiliary-gas stream would be introduced into the oxidation reactor upstream. The present invention can also be advantageously used within the context of revamping an existing CLC unit, without modifying the oxidation reactor upstream of the cyclone which is designed to operate with a certain flow rate of gas. In this case, the injection of oxidizing auxiliary gas into the inlet pipe of the cyclone makes it possible to increase the oxidation capacity of the unit. According to one or more embodiments, the cyclone is positioned downstream of the combustion reactor 300, and receives a gas mixture comprising particles of the oxygen carrier that has come from the reduction reactor 300. The reduction reactor 300 may comprise, in its top part, the inlet opening of the inlet pipe of the cyclone, so as to send the gas mixture (directly) to the inlet pipe of said cyclone.

In the case of the combustion of solid feedstocks, the plant may comprise a solid/solid separator as already mentioned above, and in this case the cyclone according to the invention may be positioned downstream of the solid/solid separator. Said solid/solid separator may then comprise, in its top part, the inlet opening of the inlet pipe of the cyclone, so as to send the gas mixture that has come from the solid/solid separator (directly) to the inlet pipe of said cyclone. As an alternative, the solid/solid separator can have an outlet pipe for the gas stream having the lightest particles which comprises the inlet opening of the inlet pipe of the cyclone.

The solid/solid separator is utilized to separate the particles of unburnt residues from the particles of the oxygen carrier on the basis of the physical properties of the different size and density of the particles. Specifically, the particles of the oxygen carrier, described above, generally have a far greater size and density than those of the particles of unburnt residues and also than those of the fly ash coming from the combustion reactor.

The solid/solid separator may thus be utilized to separate, on the one hand, some of the particles of unburnt residues and, on the other hand, particles of the oxygen carrier having a density greater than or equal to 1000 kg/m³, preferably greater than or equal to 1200 kg/m³, more preferentially greater than or equal to 2500 kg/m³. Typically, more than 90% of the particles of the oxygen carrier have a size of between 100 μm and 500 μm, preferably of between 150 μm and 300 μm. At the outlet of the combustion reactor, it is estimated that the size of the particles of unburnt residues is less than 100 μm and that the majority of said particles have a size of between 20 and 50 μm. The density of these particles of unburnt residues is in general between 1000 and 1500 kg/m³.

Other particles, such as the fly ash, as distinct from the particles of unburnt residues, and resulting from the combustion of the solid feedstock, may also circulate with the remainder of the particles, and are characterized by a lower particle size and lower density than the particles of the oxygen carrier (i.e. less than 100 μm), and often also lower than the particles of unburnt residues. The ash is formed of noncombustible elements resulting from the complete combustion of the particles of solid fuel for which the residence time in the combustion reactor has been sufficient. The ash is mainly inorganic in nature. It typically comprises the following compounds: SiO₂, Al₂O₃, Fe₂O₃, CaO, MgO, TiO₂, K₂O, Na₂O, SO₃, P₂O₅. If ash is present in the process and, in particular, in the gas mixture coming from the reduction reactor, it may be separated out and carried along with the particles of unburnt residues to the solid/solid separator.

The present invention also relates to a CLC process using the cyclone according to the invention or the CLC plant according to the invention comprising such a cyclone, having the following steps:
combusting the hydrocarbon feedstock by bringing it into contact with the particles of the oxygen carrier inside a reduction reactor 300 operating as a fluidized bed;
oxidizing the particles of the oxygen carrier that have stayed in the reduction reactor 300 by bringing them into contact with an oxidizing gas inside the oxidation reactor 100 operating as a fluidized bed by means of an oxidizing gas, preferably air, and then sending them toward the reduction reactor 300;
sending the gas mixture comprising solids particles coming from the reduction reactor 300 or the oxidation reactor 100 to the inlet pipe of the cyclone;
injecting the auxiliary gas through at least one nozzle situated on the inclined lower wall of the inlet pipe of the cyclone so as to disperse the solids particles; and
performing gas/solid separation inside the cyclone so as to form a particle-depleted gas stream extracted via the outlet pipe of the cyclone and so as to form a stream of solids particles discharged via the discharge pipe of the cyclone.

According to one or more preferred embodiments, the gas mixture comprising solids particles that is sent to the inlet pipe of the cyclone comes directly from the oxidation reactor 100 (i.e. without any intermediate device or chamber). The solids particles are those of the oxygen carrier. The auxiliary gas can be identical to the oxidizing gas of the oxidation reactor, and is preferably air. The auxiliary gas may also be dioxygen. According to this or these preferred embodiments, the auxiliary gas is injected at a flow rate of between 0.1% and 30% by volume of the flow rate of oxidizing gas utilized in the oxidation reactor, or even between 1% and 10% by volume.

According to one or more embodiments, the gas mixture comprising solids particles that is sent to the inlet pipe of the cyclone comes from the reduction reactor. In this case, the auxiliary gas may advantageously be dioxygen so as to convert the residual unburnt species or ammonia in order to reduce, for example, the NOx concentration. The auxiliary gas may also be CO₂, preferably recycled CO₂, or water vapor. According to this or these preferred embodiments, the auxiliary gas is injected at a flow rate less than or equal to 30% by volume of the flow rate of the fluidization gas utilized in the oxidation reactor, it being possible for those skilled in the art to determine the minimum flow rate to carry out the desired chemical reactions, which is to say the combustion of the residual unburnt species or the selective non-catalytic reduction of the NOx.

When dioxygen is injected into the inlet pipe of the cyclone, in addition to dispersing the solids particles in the pipe, this makes it possible to reduce residual unburnt species present in the gas mixture. Residual unburnt species are understood to mean the solid or gaseous compounds produced when not all of the feedstock is combusted, mainly the unburnt gaseous compounds, e.g. CO and/or H₂, that originate from the conversion of the feedstock in contact with water (devolatilization/gasification of a solid or liquid feedstock and reforming of methane, producing CO and H₂) or an unconverted fraction of the gaseous hydrocarbon feedstock, e.g. CH₄, or an unconverted solid fraction of the hydrocarbon feedstock in the event of a solid feedstock, for example.

When ammonia is injected into the inlet pipe of the cyclone, in addition to dispersing the solids particles in the pipe, this makes it possible to carry out non-catalytic reduction of NOx that might be present in the gas mixture.

The auxiliary gas is preferably injected through the one or more nozzles at a velocity of between 5 m/s and 100 m/s, preferably between 20 m/s and 40 m/s.

Advantageously, the auxiliary gas injected forms a jet that makes an angle of between 0° and 90°, preferably between 0° and 45°, with a horizontal axis (X) in the vertical plane (XZ).

The superficial gas velocity UgS of the gas mixture leaving the inlet pipe and entering the chamber of the cyclone is preferably between 5 m/s and 35 m/s, and more preferentially between 15 m/s and 25 m/s, in order to achieve good separation performance.

The superficial gas velocity of the gas mixture at the inlet of the inlet pipe can advantageously be equal to the superficial gas velocity of the gas mixture at the outlet of the inlet pipe.

### Example

The aim of the following example is to demonstrate certain performance aspects of the cyclone according to the invention, in particular the limitation of the deposition of solid matter in the inlet pipe of the cyclone placed at the outlet of an air reactor of a CLC plant, in comparison with a conventional cyclone provided with a traditional inlet pipe in the form of a horizontal duct. This example is based on computational fluid dynamics (CFD) simulations using the Barracuda® software (CPFD software) and models the hydrodynamic aspect without taking into account the actual temperature conditions of a CLC unit (“cold” mockup).

FIG. 4 illustrates 3 different schematic views of the exemplary cyclone according to the invention that was tested: (A) sectional view, (B) top view, and (C) perspective view (C).

The inlet pipe of the cyclone according to the invention, like that of the conventional cyclone, has a rectangular cross section. However, the cyclone according to the invention, by contrast to the conventional cyclone, has an inlet pipe 21 comprising:
three oxidizing-gas injection nozzles 29 distributed equidistantly from one another along a central axis of the lower wall of the inlet pipe 21,
a lower wall of the inlet pipe 21, this lower wall being inclined by an angle α of 20°, corresponding to the measured angle of repose of the particles of the oxygen carrier (measured by the tilting plate method), and
an inner lateral wall 28 inclined by an angle β of 3.5° so as to keep a constant cross section in the inlet pipe (identical areas of the rectangular cross section of the inlet opening O and the outlet opening S). The area of the cross sections of the inlet opening and the outlet opening is 1.76 m².

The injection nozzles are vertical ducts leading into the inlet pipe so as to create a jet at 90° with respect to the horizontal (X) in the vertical plane (XZ).

The solids particles of the oxygen carrier have a mean diameter of 330 μm, and a density of 2200 kg/m³.

The mass flow of the particles in the air reactor 100 in the form of a riser is 220 kg/m²/s.

The gas utilized in the air reactor is air, at 26.85° C. (300 K) and 0.1 MPa (1 atm).

The superficial gas velocity in the inlet pipe 21 is 15 m/s.

The auxiliary gas injected through the three nozzles is air and has a flow rate equal to 10% of the flow rate of air utilized in the air reactor. The injection of air through the nozzles makes it possible to reduce the deposition of solid matter in the inlet pipe and to complete the oxidation reaction in the inlet pipe, before sending the gas and the particles to the chamber of the cyclone.

FIG. 5 illustrates the deposition of solid matter on the inner surface of the lower wall of the inlet pipe of the cyclone according to the invention, (B), and of the conventional cyclone, (A): in the case of the exemplary cyclone according to one embodiment of the invention, in the image (B) on the right, the particle volume fraction PVF at the lower wall of the inlet pipe is much less than in the case of the conventional cyclone, which is shown in image (A) on the left.

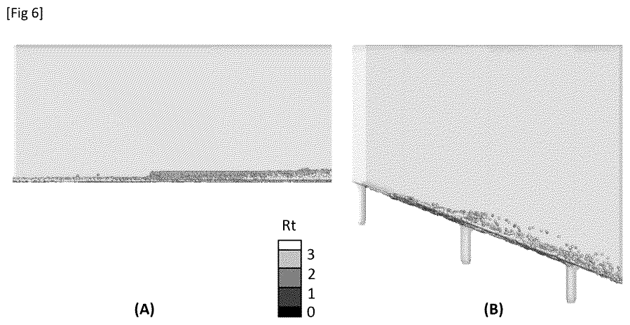

FIG. 6 illustrates the amount of solids particles under the same gas and particle flow rate conditions depending on their residence time in the inlet pipe of the cyclone according to an embodiment of the invention, (B), and of the conventional cyclone, (A): in the case of the exemplary cyclone according to the invention, in image (B) on the right, there are considerably fewer particles with a residence time longer than 2 seconds inside the inlet pipe, in comparison with the case of the conventional cyclone, which is shown in image (A) on the left. By virtue of the modified form of the inlet and the injection of auxiliary gas, the mean residence time of the particles at the outlet of the inlet pipe of the cyclone is reduced by 13% in the case of the exemplary cyclone according to the invention, which amounts to having on average 44% less particles in the inlet pipe of the cyclone.

1. A cyclone (200) for a plant for chemical looping redox of a hydrocarbon feedstock using at least one reactor operating as a circulating fluidized bed, comprising:
an inlet pipe (21) for a gas mixture (2) comprising solids particles coming from a reactor (100, 300) of the plant, this inlet pipe having at one end an inlet opening (O) of rectangular cross section and at its other end an outlet opening(S) of rectangular cross section,
a cylindrical-conical chamber (22) having a cylindrical upper portion (22a) surmounting an inverted frustoconical lower portion (22b), said cylindrical upper portion (22a) having the outlet opening(S) of the inlet pipe;
an outlet pipe (23) for a particle-depleted gas stream (3), this pipe being positioned at the top of the cylindrical upper portion;
a discharge pipe (24) for discharging a stream of solids particles (4), this pipe being positioned at the bottom of the inverted frustoconical lower portion (22b); and
wherein said inlet pipe (21) is delimited by:
a planar upper wall (25) in a horizontal plane (XY),
a planar lower wall (26) inclined by an angle α with respect to the planar upper wall (25), said angle α being defined in a vertical plane (XZ) and such that the dimension along a vertical axis (Z) of the outlet opening S of the inlet pipe is less than the dimension along a vertical axis (Z) of the inlet opening O,
a vertical planar outer lateral wall (27) in the vertical plane (XZ), this wall being tangent to the cylindrical upper portion of the cylindrical-conical chamber, and
a vertical planar inner lateral wall (28) inclined by an angle β with respect to the outer lateral wall (27), said angle β being defined in the horizontal plane (XY), and such that the dimension along an axis (Y) of the outlet opening S of the inlet pipe is less than the dimension along an axis (Y) of the inlet opening O, and said inlet pipe (21) has at least one auxiliary-gas injection nozzle which is situated on the planar lower wall.

2. The cyclone as claimed in claim 1, wherein the cross-sectional area (So) of the inlet opening (O) is equal to the cross-sectional area (Ss) of the outlet opening(S).

3. The cyclone as claimed in claim 1, wherein the angle α has an absolute value of between α′ and α′+45°, preferably between α′+10° and α′+20°, with α′ being the angle of repose of the particles, and the angle α preferably has an absolute value of between 15° and 60°.

4. The cyclone as claimed in claim 1, wherein the angle β is determined such that the cross-sectional area (So) of the inlet opening (O) is equal to the cross-sectional area (Ss) of the outlet opening(S).

5. The cyclone as claimed in claim 1, having between 1 and 10 nozzles/m² on the planar lower wall, which are distributed evenly over the surface of the planar lower wall (26).

6. The cyclone as claimed in claim 1, wherein the cross-sectional area (Ss) of the outlet opening(S) is such that the superficial velocity UgS of the gas of the gas mixture leaving said inlet pipe and entering the chamber of the cyclone is between 5 m/s and 35 m/s.

7. The cyclone as claimed in claim 1, wherein said at least one nozzle is configured so as to form a jet that makes an angle of between 0° and 45°, with the axis (X) in the vertical plane (XZ).

8. The cyclone as claimed in claim 1, wherein said at least one nozzle is configured such that the gas velocity at the outlet of said nozzle is between 5 m/s and 100 m/s.

9. A chemical looping combustion plant for the combustion of a hydrocarbon feedstock using a solid-state oxygen carrier in the form of particles, comprising:
a reduction reactor (300) operating as a fluidized bed to perform the combustion of said hydrocarbon feedstock in contact with said particles of the solid-state oxygen carrier;
an oxidation reactor (100) operating as a fluidized bed to oxidize the reduced particles of the solid-state oxygen carrier coming from the reduction reactor (300) by bringing them into contact with an oxidizing gas;
means for circulating the oxygen carrier between said reduction reactor (300) and the oxidation reactor (100); and
a cyclone as claimed in claim 1 positioned downstream of said reduction reactor and/or downstream of said oxidation reactor so as to receive a gas mixture comprising solids particles coming from the reduction reactor (300) or the oxidation reactor (100).

10. The plant as claimed in claim 9, wherein said cyclone is positioned downstream of the oxidation reactor (100), and said oxidation reactor (100) comprises, in its top part, the inlet opening (O) of the inlet pipe (21) of said cyclone (200) so as to send the gas mixture comprising particles of the oxygen carrier that has come from said oxidation reactor (100) to the inlet pipe of said cyclone.

11. A process for the chemical looping combustion of a hydrocarbon feedstock, using a cyclone as claimed in claim 1, said process comprising:
combusting the hydrocarbon feedstock by bringing the feedstock into contact with the particles of the oxygen carrier inside a reduction reactor (300) operating as a fluidized bed;
oxidizing the particles of the oxygen carrier that have stayed in the reduction reactor (300) by bringing them into contact with an oxidizing gas inside an oxidation reactor (100) operating as a fluidized bed by means of an oxidizing gas, preferably air, and then they are sent toward the reduction reactor (300);
sending a gas mixture comprising solids particles coming from the reduction reactor (300) or the oxidation reactor (100) to the inlet pipe of the cyclone;
injecting an auxiliary gas through at least one nozzle situated on the inclined lower wall of the inlet pipe of the cyclone so as to disperse the solids particles; and
performing a gas/solid separation inside said cyclone so as to form a particle-depleted gas stream extracted via the outlet pipe at the top of the cylindrical upper portion of said cyclone and so as to form a stream of solids particles discharged via the discharge pipe at the bottom of the inverted frustoconical lower portion of said cyclone.

12. The process as claimed in claim 11, wherein the gas mixture comprising solids particles that was sent to the inlet pipe of the cyclone comes directly from the oxidation reactor, and the auxiliary gas is identical to the oxidizing gas, preferably air, of the oxidation reactor and is injected at a flow rate of between 0.1% and 30% of the flow rate of oxidizing gas utilized in the oxidation reactor.

13. The process as claimed in claim 11, wherein the gas mixture comprising solids particles that was sent to the inlet pipe of the cyclone comes from the reduction reactor, and the auxiliary gas is dioxygen so as to also carry out a reduction of residual unburnt species present in the gas mixture, or the auxiliary gas is ammonia so as to also carry out a non-catalytic reduction of NOx present in the gas mixture.

14. The process as claimed in claim 11, wherein the auxiliary gas is injected through said at least one nozzle at a velocity of between 5 m/s and 100 m/s, preferably between 20 m/s and 40 m/s, and forms a jet that makes an angle of between 0° and 90°, preferably between 0° and 45°, with the axis (X) in the vertical plane (XZ).

15. The process as claimed in claim 11, wherein the superficial gas velocity of the gas mixture at the inlet of said inlet pipe is equal to the superficial gas velocity of the gas mixture at the outlet of said inlet pipe, and is between 5 m/s and 35 m/s.

16. The cyclone as claimed in claim 1, wherein the angle α has an absolute value of between α′+10° and α′+20°, with α′ being the angle of repose of the particles.

17. The cyclone as claimed in claim 1, wherein the angle β is determined such that the cross-sectional area (So) of the inlet opening (O) is equal to the cross-sectional area (Ss) of the outlet opening(S), and the angle β has an absolute value of between 5° and 70°.

18. The cyclone as claimed in claim 1, having between 2 and 5 nozzles/m² on the planar lower wall, which are distributed evenly over the surface of the planar lower wall (26).

19. The cyclone as claimed in claim 1, wherein said at least one nozzle is configured so as to form a jet that makes an angle of between 0° and 45°, with the axis (X) in the vertical plane (XZ).

20. The cyclone as claimed in claim 1, wherein said at least one nozzle is configured such that the gas velocity at the outlet of said nozzle is between 20 m/s and 40 m/s.
